(19) United States
(12) Patent Application Publication
(10) Pub. No.: US 2004/0264649 A1
(43) Pub. Date: Dec. 30, 2004

(54) Patient table for radiation image acquisition

(76) Inventor: Peter Jahrling, Puschendorf (DE)

Correspondence Address: SCHIFF HARDIN, LLP, PATENT DEPARTMENT, 6600 SEARS TOWER, CHICAGO, IL, 60606-6473, US

(21) Appl. No.: 10/834,694

(22) Filed: Apr. 29, 2004

(30) Foreign Application Priority Data
Apr. 29, 2003 (DE) 103 19 305.7

(51) Int. Cl. G01N 23/201

(52) U.S. Cl. 378/209

(57) ABSTRACT

A patient table for radiation image exposure has a top surface forming a patient positioning surface that has an integrated solid-state radiation detector with a size substantially corresponding to the size of the patient positioning surface.

### BACKGROUND OF THE INVENTION

1. Field of the Invention

The present invention concerns a patient table for radiation image acquisition, with a top surface, preferably essentially planar, that serves as a planar patient positioning surface.

2. Description of the Prior Art and Related Subject Matter

In the framework of a radiation image exposure, in particular an x-ray exposure, radiation emitted by a radiation source permeates a patient (that, for example, lies on a patient table), and exposes an x-ray film cassette or a solid-state radiation detector mounted behind the patient. To adjust the exposure surface, on the tube side one or more diaphragms are provided with which the beam path can be gated. Generally x-ray film cassettes of different cassette formats are used, while solid-state radiation detectors normally have a largely uniform size. In each case, the radiation source, the patient and the cassette are to be adjusted (aligned) relative to one another, meaning the central ray of the tube (center of the beam cone) must go through the center of the examination surface and through the center of the cassette/the detector. Currently the adjustment of the radiation source, the patient examination area and the cassette/detector is implemented either manually by auxiliary personnel, whereby the beam path and the collimation are normally indicated by a light/line beam localizer and an illuminated field on the patient. The cassette positioning normally ensues optically according to feel and experience or with the aid of grids (for example, central position of the cassette below the table). Another adjustment possibility is to acquire the position of rays and the cassette/detector by means of sensors and to monitor the rays in an adjusted central position by means of electromechanical control (what is known as tracking control).

Film-foil systems or the storage film cassettes are increasingly being replaced by solid-state radiation detectors in radiology, Only the type of the image generation changes with this different type of detector, but the aforementioned adjustment problems still remain.

German OS 196 13 662 discloses an x-ray diagnosis system with a single image receiver that is fashioned as a planar detector, and to which a number of image processing units are connected to generate different x-ray images.

From German OS 196 27 647, an acquisition apparatus is known that has a height-adjustable and rotatable detector mount attached to a base, and a planar detector. The planar detector can be selectively brought to a vertical or horizontal position.

### SUMMARY OF THE INVENTION

An object of the present invention is to provide a patient table for radiation image acquisition, as well as an apparatus employing such a table, wherein the aforementioned difficulties associated with adjustment of conventional patient tables are avoided, in particular the time expenditure.

This object is achieved in accordance with the invention by a patient table having an integrated solid-state radiation detector with a size essentially corresponding to the size of the patient positioning surface.

The invention is based on using a solid-state radiation detector with dimensions that essentially correspond to a typical patient positioning surface, thus, for example, to a typical x-ray table plate. Such patient positioning surfaces have a size of, for example, 200×80 cm; the size of the solid-state radiation detector should be of similar dimensions, for example 180-190 cm×70-75 cm, observing a slight border separation. Because the patient lying on the patient positioning surface therewith lies entirely above the solid-state radiation detector, for the image acquisition it is merely necessary to position the radiation source over the examination region of the patient to be examined (thus the acquisition field) and to gate the radiator, which can ensue manually or can be electronically programmed. In the framework of the image acquisition, only one part of the large area radiation detector is then exposed, which part is then read out, and the acquired image is determined and output.

By the use of an inventively dimensioned solid-state radiation detector, all of the activities associated in the prior art with the positioning or adjustment are not necessary. The exposures are substantially faster and thus cheaper to implement, since only the radiation source must be set up and positioned. A patient screening in the framework of an exposure examination can likewise be implemented very quickly and simply, and the patient setup is also made easier because the entire body can be “detected”.

In an embodiment of the invention, the solid-state radiation detector is arranged below a radiation-transparent protective plate that simultaneously forms the patient positioning surface. Solid-state radiation detectors known in the prior art are composed of a carrier with a pixel matrix disposed carrier-proximate and a scintillator disposed matrix-proximate to convert the incident radiation into radiation that can be processed by the pixel matrix. This detector structure is housed in a detector housing, having a ray entrance side at which a radiation-transparent protective plate is disposed. This plate normally is composed of a thin-walled but nevertheless extremely stable carbon fiber composite material. This protective plate is correspondingly dimensioned, and at the same time is used as a patient positioning surface, meaning the patient lies directly on the radiation-transparent x-ray-transparent protective plate, under which is located the solid-state radiation detector. Such protective plates can also be produced sufficiently thin-walled in the size of a patient positioning surface with extreme stability and durability, for which (as specified) in particular composite materials such as carbon fiber composite material and the like are suited. They can be planar or curved in a trough shape.

According to a first inventive alternative, the radiation detector can be fashioned one-piece, meaning the radiation-active pixel matrix is one-piece, as well as the other detector layers or elements. As an alternative to this, the possibility exists that the radiation detector is comprised of a number of detector segments disposed next to one another. Thus, in this inventive embodiment, individual detector segments are placed directly next to one another, such that they abut directly on one another and the large detector surface results.

In an embodiment of the invention, a part of the radiation detector can be rotated together with a corresponding section of the patient positioning surface, in particular can be rotated into a vertical placement, This inventive embodiment enables, for example, a part of the detector to be set vertically in order to enable acquisitions with a horizontal irradiation. For example, the head part of the table can be adjusted; it is also possible to pivot a side section, etc. The pivoting can be realized, for example, by a suitable hinge or any other pivot connection.

In order to be able to effect horizontal irradiation not only in the region of the pivotable table part, but also at other locations, in an embodiment amount is provided for at least one further solid-state radiation detector, preferably to be arranged on the patient table in a vertical orientation. This solid-state radiation detector is a sealed component, meaning the detector is arranged in an encapsulated housing which us connected to the patient table via the mount, preferably fashioned as plug, catch or clamp retainer. The mount also can provide an electrical connection to an external computer serving to read out the solid-state radiation detector arranged table-side. If a number of mounts are provided at the edge of the table, an additional detector can be largely arbitrarily positioned. The image information delivered by this additional detector is also read out and processed by a common computer, comparable to the image information from the detector integrated at table side.

In addition to the patient table itself, the invention also concerns an apparatus for radiation image acquisition having a radiation source as well as a patient table as described above.

This apparatus is also characterized by a computer to read out the exposure image information of the radiation detector, the computer reading out only the exposed area of the radiation detector. This means that, after an implemented partial exposure of an area the radiation detector that is substantially larger in comparison with the exposure area, only the actual exposed detector area is read out, but not any unexposed areas surrounding it, The local readout operation can ensue dependent on position data given by the computer that specify the position of the radiation source, and likewise the beam gating, thus the data specifying diaphragm adjustment. This means that only the actual exposed area is automatically read out by the computer, which ensues using the position data (available to the computer) of the radiation source and corresponding data that describes the gating of the beam cone and with it the size of the exposure field. An automatic and more direct readout operation thus can be achieved.

As described, the inventive patient table allows the solid-state radiation detector to be assembled from a number of individual detector segments. In the joint (abutting) area of two detector segments, no charge generation, or only an incorrect or unusable charge generation, ensues in the radiation-sensitive solid body, which leads to faulty image information and to image errors. Image signals are also absent in the area of the possible pivot bearing of a detector part, as a consequence of the pivot bearing. Nevertheless, in order to arrive at an artifact-free or error-free overall image, it is appropriate for the computer to be fashioned, with a radiation detector composed of a number of detector segments, for computed determination of the lacking or erroneous image signals in the joint area of two detector segments or in the area of the pivot bearing of a detector part. This means the computer computationally compensates possible image or signal errors arising in the joint area or in the area of the pivot bearing, for example by signal interpolation or the like. An error-free image thus is obtained,

### DESCRIPTION OF THE DRAWINGS

FIG. 1 is a side view of an inventive apparatus for radiation image acquisition using an inventive patient table in a first embodiment.

FIG. 2 is a side view of the inventive patient table of a second embodiment.

FIG. 3 is a side view of the inventive patient table in a third embodiment.

### DESCRIPTION OF THE PREFERRED EMBODIMENTS

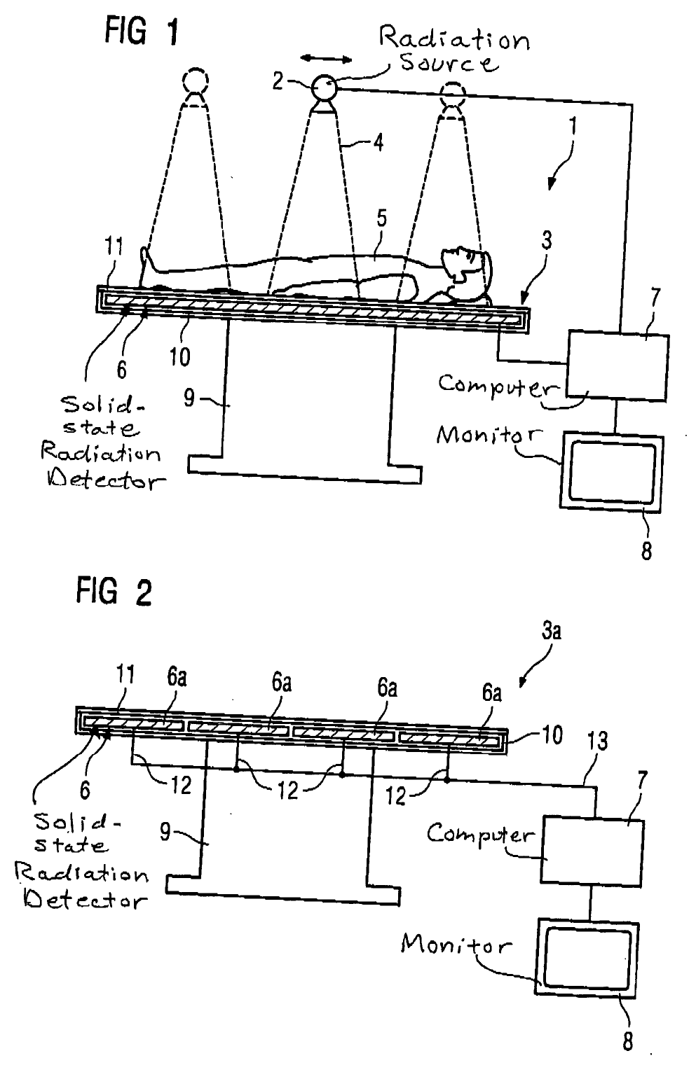

FIG. 1 shows an inventive apparatus 1 for radiation image acquisition, having a radiation source 2 as well as an inventive patient table 3. The radiation source 2, as indicated by both double arrows, can be moved horizontally and vertically; and it can also be positioned in an arbitrary position above the patient table 3, as indicated by the three different position representations. From the radiation source 2, x-ray radiation 4 is emitted that is directed to a patient 5 lying on the patient table 3, permeates the patient 5, and exposes a specific section of a solid-state radiation detector 6 integrated into the patient table 3. This exposure leads to generation of charge carriers that form the image information, which is read out via a computer 7. The computer 7 undertakes the generation of the image using the read-out image information. The image subsequently is shown on a monitor 8.

The patient table 3 has a base 9 on which is arranged a table housing 10 in which is arranged, in the exemplary embodiment according to FIG. 1, the solid-state radiation detector 6, fashioned as one piece. As is known, the solid-state radiation detector is formed of a carrier, primarily a glass carrier, on which is applied a radiation-sensitive pixel matrix, forming the actual detector matrix. This matrix (preferably composed of amorphous silicon) has a first section that forms the photodiode layer, the charges (dependent in number on the strength of the incident radiation) being generated in the photodiodes. The pixel matrix also has a switching matrix array for dedicated readout of the photodiodes. The assembly of such a pixel matrix is sufficiently known and does not need detailed explanation. Directly applied to the pixel matrix is a scintillator that, for example, can be a needled Csl layer or a scintillator made of GOS (gadolinium oxide sulfide) or Se can similarly be applied. In the scintillator, the incident x-ray radiation permeating the patient 5 are first converted into a radiation processable by the pixel matrix, primarily visible light, which radiation is then coupled in the pixel matrix for charge generation. This is also well known,

In order to protect the sensitive structure of the solid-state radiation detector, an upper protective plate 11 is provided that simultaneously forms the patient positioning surface of the patient table 3. The solid-state radiation detector 6 must unavoidably be completely encapsulated against mechanical or other influences from the outside, for which this protective plate 11 serves. It likewise serves in the inventive patient table as a patient positioning surface on which the patient directly lies, and under which the radiation detector 6 is directly arranged. It thus has a double function, The protective plate 11 is extremely stable, which preferably is achieved by using a carbon fiber composite material.

For radiation image acquisition, the patient is first placed on the patient table 3, after which the radiation source 2 is correspondingly positioned. The radiation cone is gated by diaphragms (not shown in detail) at the radiation source 2, meaning the radiation 4 is restricted by the diaphragm. The field or the area of the patient 5 that is exposed thus defined. The position data in the x-, y- and z-directions and the gating data, as shown in FIG. 1, are supplied to the computer 7, so that it knows where the radiation source 2 is positioned relative to the patient table 3, and thus relative to the solid-state radiation detector 6, and the size and position of the actual exposure area of the solid-state radiation detector 6. After the ensuing exposure, for which the radiation source 2 is operated (the components necessary for this, such as the high-voltage generator, etc., are not shown in detail but are sufficiently known), essentially only the area of the radiation detector 6 that was actually exposed is read out by the computer 7, which can automatically ensue using the supplied position and collimation data.

FIG. 1 also shows two additional exposure positions in which the radiation source 2 is shown dashed. In one case the leg region is exposed, in the other case the head and breast region. The corresponding position and gating data are also here given to the computer 7, such that only the actual exposed detector area is read out.

While FIG. 1 shows a patient table 3 with a one-piece solid-state radiation detector 6, FIG. 2 shows a patient table 3a in which a number of detector segments 6a are disposed next to one another. While FIG. 2 shows only four detector segments 6a arranged in a row in the longitudinal direction of the patient table 3a, naturally more can be arranged next to one another, also in the transverse direction, insofar as a detector segment does not extend over the entire table width. Each detector segment 6a is connected via a suitable readout line 12 with the common readout line 13 which leads to the computer 7, such that each individual detector segment 6a as well as multiple detector segments 6a can be accessed. Otherwise the embodiment of the table corresponds to that of FIG. 1, in particular concerning the common protective plate 11 that also performs the double function as a patient positioning surface. In order to prevent image errors arising in the Joint area, the computer 7 is fashioned to compensate such signal or image interferences, such as by interpolating between two detector segments 6a in the area of the joints. The computer 7 computationally compensates image errors resulting from this the joint or pivot areas that a uniform image results without artifacts.

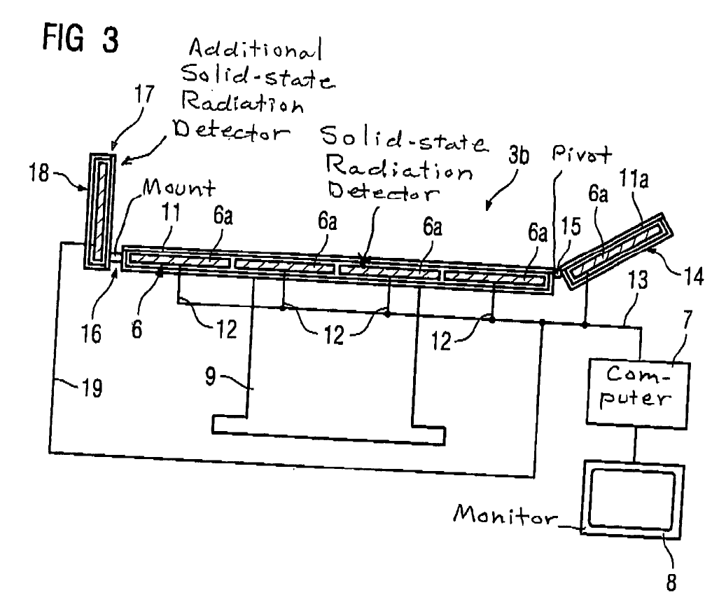

FIG. 3 shows a third embodiment of an inventive patient table 3b. In this embodiment, a number of individual detector segments 6a are also used that form the overall solid-state radiation detector 6 and that are connected with the computer 7 via the individual readout lines 12, 13. In the shown example, a table section 14 can be pivoted with regard to the remaining table by a hinge bearing 15. This enables it to bring this section 14, for example, to a vertical position in order to effect horizontal irradiation exposures in this area. Naturally the image information of the detector segment 6a is also read out by the computer 7 and correspondingly processed; also, corresponding position and gating data of the radiation source 2 exist with regard to this when horizontal irradiation exposures are effected.

In order to be able to acquire horizontal exposures not only in this area, but also at other table areas, a number of mounts 16 (of which one is shown in FIG. 3) are provided at the edge of the patient table 3b. The illustrated mount 16 is fashioned here as a plug or catch that enables mechanical as well as, as needed, electrical coupling of the external solid-state radiation detector 17 that can be attached to this. Like a typical radiation detector, this radiation detector 17 is housed in a suitable housing 18 and can be positioned vertically in this manner. It can be coupled with the computer 7 by a connection line 19. Naturally the possibility also exists to realize this coupling via the mount 16. The external radiation detector 17 also can be attached to the longitudinal sides in corresponding positions via further mounts 16.

Although modifications and changes may be suggested by those skilled in the art, it is the intention of the inventor to embody within the patent warranted hereon all changes and modifications as reasonably and properly come within the scope of his contribution to the art.

I claim as my invention:

1. A patient table for radiation image acquisition comprising:
a base;
a patient positioning surface disposed on said base, said patient positioning surface having a size and a top side adapted to receive a patient thereon; and
a solid state radiation detector integrated into said patient positioning surface and having a size substantially corresponding to the size of the patient positioning surface

2. A patient table as claimed in claim 1 wherein said patient positioning surface is substantially planar.

3. A patient table as claimed in claim 1 wherein said patient positioning surface comprises a radiation-transparent protective plate at said top side, with said radiation detector being disposed beneath said radiation-transparent protective plate.

4. A patient table as claimed in claim 1 wherein said radiation detector is a one-piece radiation detector.

5. A patient table as claimed in claim 1 wherein said radiation detector is comprised of a plurality of detector segments disposed next to one another.

6. A patient table as claimed in claim 1 wherein said patient positioning surface comprises a surface portion connected to a remainder of said patient positioning surface via a pivotable joint for allowing pivoting of said surface portion into a vertical position, said surface portion containing a portion of said radiation detector that is pivotable together with said surface portion.

7. A patient table as claimed in claim 1 comprising a further solid state radiation detector, and a mount for connecting said further solid state radiation detector to said patient positioning surface.

8. A patient table as claimed in claim 7 wherein said mount allows positioning of said further solid state radiation detector in a vertical position.

9. A patient table as claimed in claim 7 wherein said mount comprises a retainer selected from the group consisting of plugs, catches and clamps.

10. A patient table as claimed in claim 7 for use with a computer for reading out said radiation detector, and wherein said mount comprises an electrical connection for allowing readout of said further solid state radiation detector with said computer.

11. An apparatus for radiation image acquisition comprising:
a radiation source for emitting a radiation beam; and
a patient table disposed in said radiation beam comprising a base, a patient positioning surface disposed on said base having a top side adapted to receive a patient thereon, and having a size, and a solid state radiation detector integrated into said patient positioning surface having a size substantially corresponding to the size of said patient positioning surface.

12. An apparatus as claimed in claim 11 comprising a computer electrically connected to said radiation detector for reading out image information from said radiation detector.

13. An apparatus as claimed in claim 12 wherein said radiation beam exposes only a portion of said radiation detector, and wherein said computer reads out said image information only from the exposed portion of said radiation detector.

14. An apparatus as claimed in claim 13 wherein said computer contains position data specifying a position of said radiation source relative to said patient table, and thus relative to said radiation detector, and wherein said computer uses said position data for identifying said portion of said radiation detector exposed by said radiation beam.

15. An apparatus as claimed in claim 14 comprising a radiation diaphragm disposed in said radiation beam for gating said radiation beam, radiation diaphragm generating gating data describing said gating of said radiation beam, and wherein said computer uses said gating data, in addition to said position data, for identifying said portion of said radiation detector exposed by said radiation beam.

16. An apparatus as claimed in claim 12 wherein said radiation detector comprises a plurality of detector segments abutting one another at respective joint regions, and wherein said computer computationally determines image signals for said joint regions.

17. An apparatus as claimed in claim 12 wherein said patient positioning surface comprises a surface portion attached by a pivot arrangement to a remainder of said patient positioning surface for allowing pivoting of said surface portion with respect to said remainder, as said surface portion containing a portion of said radiation detector that is pivotable together with said surface portion, and wherein said computer computationally determines image signals for a region in which said pivot arrangement is disposed.
